(19) United States
(12) Patent Application Publication
(10) Pub. No.: US 2005/0195613 A1
(43) Pub. Date: Sep. 8, 2005

(54) Apparatus for automatically adjusting light axis of vehicle headlight

(76) Inventor: Masahiko Morishita, Toyoake-shi (JP)

Correspondence Address: POSZ LAW GROUP, PLC, 12040 SOUTH LAKES DRIVE, SUITE 101, RESTON, VA, 20191, US

(21) Appl. No.: 11/070,279

(22) Filed: Mar. 3, 2005

(30) Foreign Application Priority Data
Mar. 5, 2004 (JP) 2004-61544
Nov. 26, 2004 (JP) 2004-341856

(51) Int. Cl. F21V 1/00; F21V 11/00; F21V 19/02; F21V 21/14

(52) U.S. Cl. 362/507; 362/508; 362/523

(57) ABSTRACT

The apparatus for automatically adjusting a light axis of a headlight of a vehicle of the invention has a structure including a steered angle sensor detecting a steered angle of a steering wheel of the vehicle, a vehicle speed sensor detecting a speed of the vehicle, a visual performance input device for inputting driver information concerning a visual performance of a driver of the vehicle to the apparatus, a control unit calculating a light-axis control value, and an actuator for swiveling the light axis of the headlight in accordance with the light-axis control value calculated by the control unit. The control unit calculates the light-axis control value on the basis of the steered angle of the steering wheel detected by the steered angle sensor, the speed of the vehicle detected by the vehicle speed sensor, and at least one physical quantity related to the driver information.

### CROSS-REFERENCE TO RELATED APPLICATION

This application is related to Japanese Patent Applications No. 2004-61544 filed on Mar. 5, 2004, and No. 2004-341856 filed on Nov. 26, 2004, the contents of which are hereby incorporated by reference.

### BACKGROUND OF THE INVENTION

1. Field of the Invention

The present invention relates to an apparatus for automatically adjusting a light axis or a lighting area of a light beam emitted from a vehicle headlight on the basis of a steering angle.

2. Description of Related Art

Automatically adjusting a direction of a light axis of a vehicle headlight is known as disclosed in Japanese Patent Application Laid-Open No. 2002-234383. This document discloses a technique for controlling a direction of a light axis of a vehicle headlight by swiveling the headlight in accordance with driving parameters such as a steered angle of a steering wheel and a speed of the vehicle.

However, this technique, which is for controlling the direction of the vehicle headlight by swiveling the headlight (referred to as “swivel control” hereinafter) depending on physical circumstances (the steered angle of the steering wheel and the vehicle speed), has a technical challenge in that not all the drivers are satisfied with this swivel control, because this swivel control does not allow for differences among individuals.

As disclosed in Japanese Patent Application Laid-open No. 11-273420, and Japanese Patent No. 3332492, it is known that the visual performance of a human declines with age. For example, elderly people tend to have a lower eyesight, easily feel glare, and have a longer adaptation time to luminosity. The visual performance can be measured as an optical density, transmissivity, focus adjusting speed, or pupil diameter of a lens in an eyeball. It is known that they vary with age.

### SUMMARY OF THE INVENTION

The apparatus for automatically adjusting a light axis of a headlight of a vehicle of the invention has a structure including:
a steered angle sensor detecting a steered angle of a steering wheel of the vehicle;
a vehicle speed sensor detecting a speed of the vehicle;
a visual performance input device for inputting driver information concerning a visual performance of a driver of the vehicle to the apparatus;
a control unit calculating a light-axis control value on the basis of the steered angle of the steering wheel detected by the steered angle sensor, the speed of the vehicle detected by the vehicle speed sensor, and at least one physical quantity related to the driver information; and
an actuator swiveling the light axis of the headlight in accordance with the light-axis control value calculated by the control unit.

With this structure, it becomes possible to adjust the light axes of vehicle headlights in a manner that satisfies the driver whatever visual performance the driver has.

The visual performance may be a value related to at least one of an optical density, a transmissivity, a focus adjusting speed, and a pupil diameter of a lens in an eyeball.

The driver information may be an age of the driver of the vehicle.

The physical quantity may be one of a swivel response time representing a time elapsed between a moment at which the steering wheel is started to be turned and a moment at which the actuator starts to swivel the light axis of the headlight, a swivel angular speed representing a rotational speed of the headlight being swiveled, and a swivel deviation value representing a fluctuation level in a lateral direction of the headlight being swiveled.

### BRIEF DESCRIPTION OF THE DRAWINGS

In the accompanying drawings:

FIG. 1 is a diagram showing a schematic structure of an apparatus for automatically adjusting a light axis of a vehicle headlight according to an embodiment of the invention;

FIG. 2 is a diagram explaining light beam patterns of vehicle headlights whose light axes are adjusted by the apparatus according to the embodiment of the invention;

FIG. 3 is a diagram showing results of principal component analysis based on the SD (Semantic Differential Scale) method performed on the result of a questionnaires survey about the performance quality of the swivel control of the light axes of vehicle headlights;

FIG. 4 is a diagram showing results of the CS (Customer Satisfaction) portfolio analysis performed on the results of the questionnaires survey;

FIG. 5 is a timechart for explaining the terms “swivel response time” and “swivel angular velocity” in the swivel control performed by the apparatus according to the embodiment of the invention;

FIG. 6 is a timechart for explaining the term “swivel deviation value” in the swivel control performed by the apparatus according to the embodiment of the invention;

FIG. 7 is a diagram showing how the statuses of satisfaction/unsatisfaction of the drivers about the “swivel response time” vary with age;

FIG. 8 is a diagram showing how the statuses of satisfaction/unsatisfaction of the drivers about the “swivel angular velocity” vary with age; and

FIG. 9 is a diagram showing how the statuses of satisfaction/unsatisfaction of the drivers about the “swivel deviation value” vary with age.

### PREFERRED EMBODIMENTS OF THE INVENTION

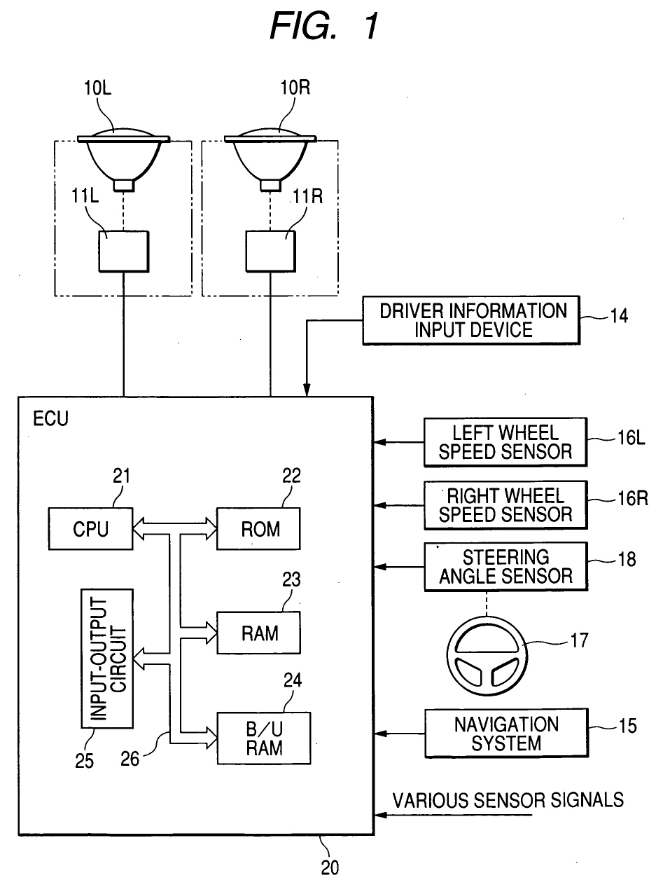

FIG. 1 shows an overall structure of an apparatus for automatically adjusting a direction of a light axis of a vehicle headlight according to an embodiment of the invention.

In this drawing, 10L and 10R denote left and right vehicle headlights, respectively. The headlights 10L and 10R are linked to actuators 11L and 11R for laterally adjusting the light axes of the headlights 10L and 10R.

An ECU (Electronic Control Unit) 20 includes a CPU 21 for executing various processings, a ROM 22 for storing control programs, control maps, etc., a RAM 23 for temporarily storing various data, a B/U (Back Up) RAM 24, an input-output circuit 25, and a bus line 26 for connecting these elements.

The ECU 20 receives an output signal from a driver information input device 14 configured to automatically read driver information from an IC key in which personal data of the driver useable for estimating the eyesight of the driver such as the age of the driver is prestored, an output signal from a navigation system 15, an output signal from a left wheel speed sensor 16L detecting a left wheel speed VL, an output signal from a right wheel speed sensor 16R detecting a right wheel speed VR, an output signal from a steered angle sensor 18 detecting a steered angle STA of a steering wheel 17, and other sensor signals from various sensor (not shown) mounted on the vehicle.

The actuators 11L and 11R laterally adjust the directions of the light axes of the headlights 10L and 10R by swiveling the headlights 10L and 10R in accordance with signals outputted from the ECU 20.

The ECU 20 calculates a swivel control angle SWC from the steered angle STA of the steering wheel 17 detected by the steered angle sensor 18, a vehicle speed SPD from the left and right wheel speeds VL, VR detected by the left and right wheel speed sensors 16L, 16R. Furthermore, as explained in detail later, the ECU 20 adjusts the calculated swivel control angle SWC on the basis of driver information regarding visual performance of the driver.

The actuators 11L, 11R act to drive the headlights 10L, 10R in accordance with this adjusted swivel control angle SWC so that the light axes of the headlights 10L, 10R are swiveled laterally in accordance with the steered angle, the vehicle speed, and the driver information regarding visual performance of the driver.

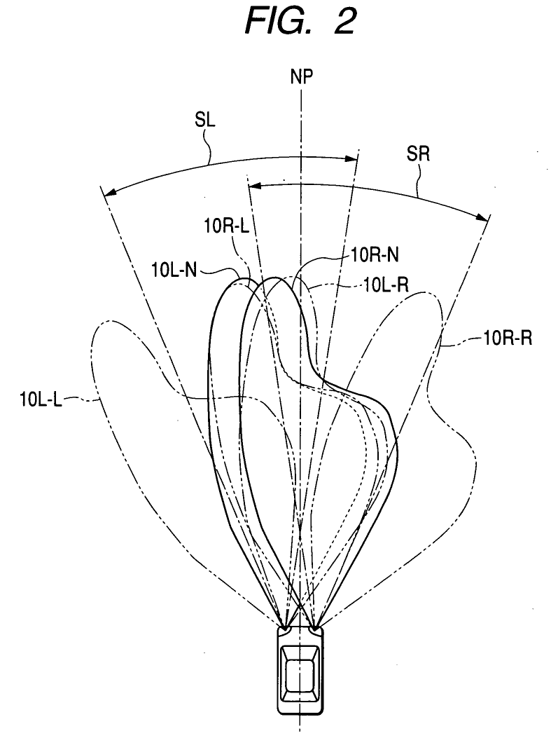

FIG. 2 shows beam patterns of the headlight 10R and 10L (low beam). In this figure, the heavy solid line 10L-N represents a beam pattern of the headlight 10L when the steering wheel 17 is in its neutral angular position. The arched arrow SL represents a swivel range within which the light axis of the headlight 10L can be swiveled in accordance with the steered angle of the steering wheel 17. The chain double-dashed lines 10L-R and 10L-L represent beam patterns of the headlight 10L when the light axis of the headlight 10L is in the rightmost position and the leftmost position within the swivel range, respectively. The heavy solid line 10R-N represents a beam pattern of the headlight 10R when the steering wheel 17 is in the neutral angular position. The arched arrow SR represents a swivel range within which the light axis of the headlight 10R can be swiveled in accordance with the steered angle of the steering wheel 17. The chain double-dashed lines 10R-R and 10R-L represent beam patterns of the headlight 10R when the light axis of the headlight 10R is in the rightmost position and the leftmost position within the swivel range, respectively.

The swivel ranges SL and SR should provide the driver with good visibility in the leftward or rightward direction when the driver turns the steering wheel 17 to the left or right without a sacrifice of visibility in the forward direction.

Accordingly, as shown in FIG. 2, a portion of the swivel range SL at the left of the initial angular position is wider than that of the swivel range SR so that the variation of the light axis of the headlight 10L is larger than that of the headlight 10R when the driver turns the steering wheel 17 to the left. On the other hand, a portion of the swivel range SR at the right of the initial angular position is wider than that of the swivel range SL so that the variation of the light axis of the headlight 10R is larger than that of the headlight 10L when the driver turns the steering wheel 17 to the right.

Next, the swivel control over the headlights 10L, 10R performed by the apparatus according to the embodiment of the invention is explained.

As explained above, the visual performance of drivers decline with age. Generally, elderly drivers tend to have a lower eyesight, easily feel glare, and have a longer adaptation time to luminosity. Although the visual performance can be measured as the optical density, transmissivity, focus adjusting speed, or pupil diameter of a lens in an eyeball, it is not easy to measure them. Accordingly, the inventor tried to find a substitute for them.

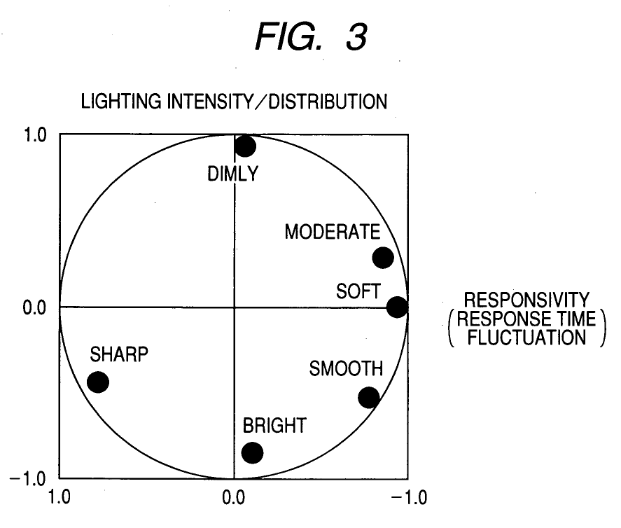

To this end, the inventor conducted a questionnaires survey on the performance of the swivel control system based on the SD (Semantic Differential Scale) method, which is well known as a statistical method for measuring image or impression, to more than one driver. By performing the principal component analysis on the results of the questionnaires survey, a factor loading having a cumulative contribution equal to 73.0% was found (see FIG. 3). More particularly, as shown in FIG. 3, it was found that the drivers evaluate the performance quality of the swivel control system depending on the factor of “lighting intensity/lighting distribution” and the factor of “responsivity (response speed/fluctuation)”.

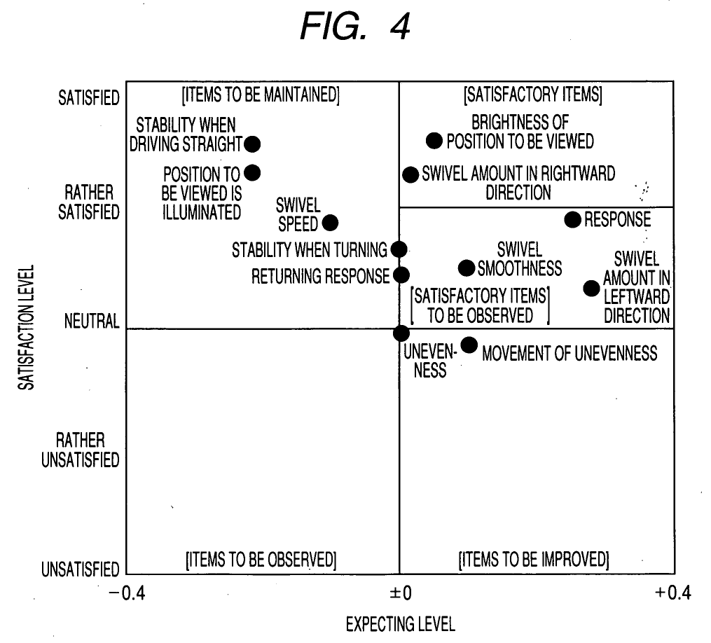

In addition, by performing the CS (Customer Satisfaction) portfolio analysis, which is well known as a statistical method for detecting attributes having large importance on customer satisfaction levels, it was found that “swivel response”, “swivel speed”, and “swivel fluctuation” are sensory evaluation values that largely affect the driver's satisfaction levels to the swivel control system as shown in FIG. 4.

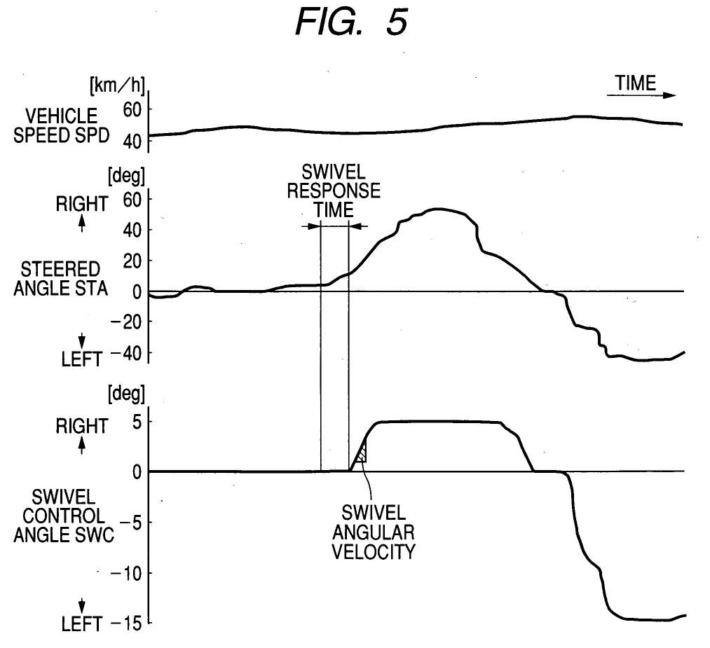

The inventor performed, on the basis of the above findings, the multiple regression analysis to extract significant factors. As a result, it was found that the “swivel response” is affected by “swivel response time (sec)” (see FIG. 5) that means a time elapsed between a moment at which the steering wheel 17 is started to be turned and a moment at which the light axis adjustment of the headlights 10L, 10R actually starts, and by “age (years)”.

It was also found that the “swivel speed” is affected by “swivel angular velocity (deg/sec)” (see FIG. 5) that means a rotational speed of the headlight 10L or 10R which the actuators 11L, 11R drive depending on the steered angle STA of the steering wheel 17, and by the “age”.

It was also found that the “swivel fluctuation” is affected by “swivel deviation value” that means fluctuation levels in lateral directions of the headlights 10L, 10R under the swivel control.

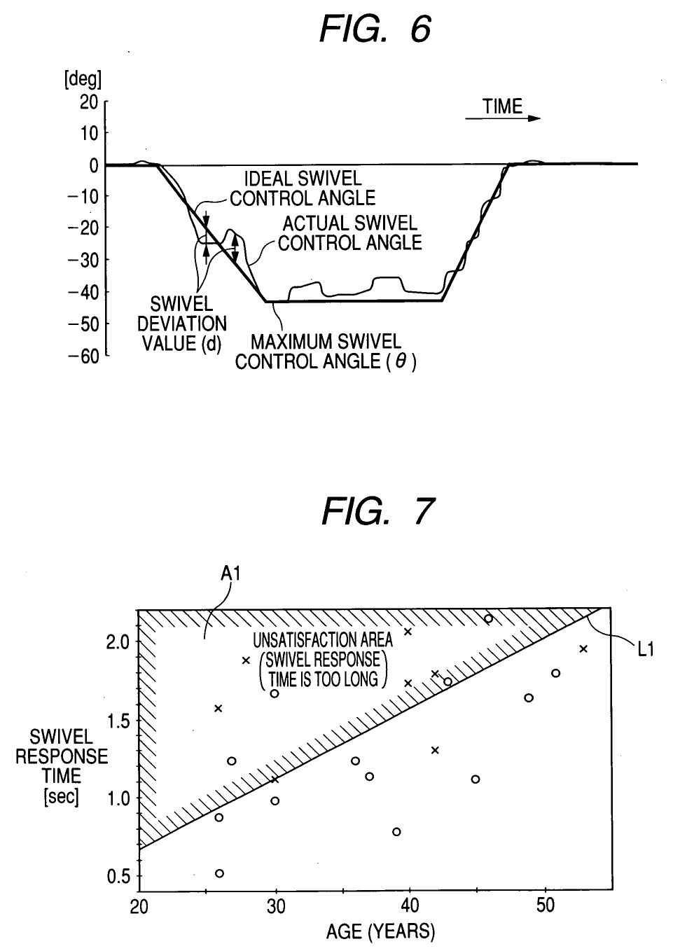

Here, the swivel deviation value (h) can be represented by the following expression (1), where d is a difference between an ideal swivel angle (the heavy line in FIG. 6) and an actual swivel control angle or an actual angular position of the headlight (the thin line in FIG. 6) at each one of predetermined timings, and θ is a maximum swivel control angle (maximum value of the actual control swivel angle).
The swivel deviation value (h)=a total sum of the differences d (Σd)/the maximum swivel control angle (θ)/2 (1)

For the next step, the inventor performed a discriminant analysis to make clear the relationships between the sensory evaluation values and the above physical quantities (“swivel response time”, “swivel fluctuation”, and “swivel angular velocity”).

FIG. 7 is a diagram showing how the statuses of satisfaction/unsatisfaction of the drivers about the “swivel response time” vary with age. In this diagram, the mark X indicates that a driver feels unsatisfied with the “swivel response time”, and the mark O indicates that a driver fees satisfied or at least does not feel unsatisfied with the “swivel response time”.

This drawing shows that there is tendency that the “swivel response time” has to be shorter for younger drivers to feel satisfied therewith. In this drawing, L1 denotes a curve on which a Z-value, which provides, a discrimination ratio equal to 75%, lies. The Z-value can be represented by the following expression (2).
Z=−0.130×“age”+2.890×“swivel response time”+0.650 (2)

As shown in this diagram where the horizontal axis represents the “age”, and the vertical axis represents the “swivel response time”, the curve L1 on which the Z-value lies is a upward-sloping line. In this diagram of FIG. 7, an area A1 surrounded by slanting lines where Z>0 is an unsatisfactory area within which the drivers tend to feel that the “swivel response time” is too long. If a curve along which the Z-value is set is distant enough from the line L1 in the direction away form the unsatisfactory area A1, it becomes possible to improve the satisfaction level about the “swivel response time” at any age group.

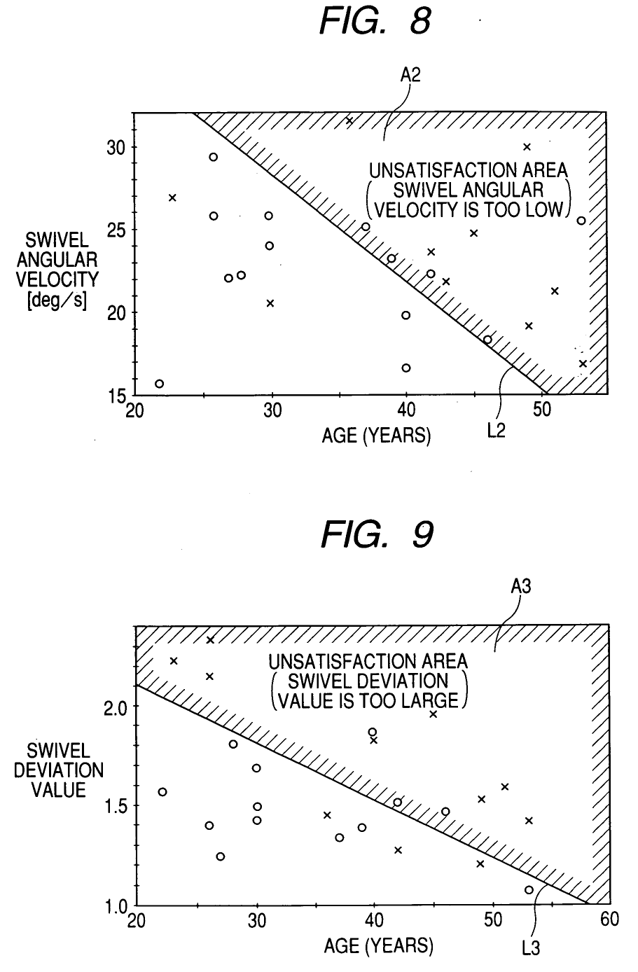

FIG. 8 is a diagram showing how the statuses of satisfaction/unsatisfaction of the drivers about the “swivel angular velocity” vary with age. In this diagram, the mark X indicates that a driver feels unsatisfied with the “swivel angular velocity”, and the mark O indicates that the driver fees satisfied or at least does not feel unsatisfied with the “swivel angular velocity”.

This drawing shows that there is tendency that the “swivel angular velocity” has to be slower for elder drivers to feel satisfied therewith. In this drawing, L2 denotes a curve on which a Z-value, which provides a discrimination ratio equal to 73%, lies. The Z-value can be represented by the following expression (3).
Z=−0.077×“age”−0.199×“swivel angular velocity”+5.674 (3).

As shown in this diagram where the horizontal axis represents the “age”, and the vertical axis represents the “swivel angular velocity”, the curve L2 on which the Z-value lies is a downward-sloping line. In this diagram of FIG. 8, an area A2 surrounded by slanting lines where Z<0 is an unsatisfactory area within which the drivers tend to feel that the “swivel angular speed” is too fast. If a curve along which the Z-value is set is distant enough from the line L2 in the direction away form the unsatisfactory area A2, it becomes possible to improve the satisfaction level about the “swivel angular velocity” at any age group.

FIG. 9 is a diagram showing how the statuses of satisfaction/unsatisfaction of the drivers about the “swivel variation value” vary with age. In this diagram, the mark X indicates that a driver feels unsatisfied with the “swivel deviation value”, and the mark O indicates that a driver fees satisfied or at least does not feel unsatisfied with the “swivel deviation value”.

This drawing shows that there is tendency that the “swivel deviation value” has to be smaller for elder drivers to feel satisfied therewith. In this drawing, L3 denotes a curve on which a Z-value, which provides a discrimination ratio equal to 73%, lies. The Z-value can be represented by the following expression (4).
Z=−0.161×“age”−5.560×“swivel deviation value”+14.928 (4)

As shown in this diagram where the horizontal axis represents the “age”, and the vertical axis represents the “swivel deviation value”, the curve L3 on which the Z-value lies is a downward-sloping line. In this diagram of FIG. 9, an area A3 surrounded by slanting lines where Z<0 is an unsatisfactory area within which the drivers tend to feel that the “swivel deviation value” is too large. If a curve along which the Z-value is set is distant enough from the line L3 in the direction away from the unsatisfactory area A3, it becomes possible to improve the satisfaction level about the “swivel deviation value” at any age group.

As a result of the discriminant analysis, the inventor found that it is preferable that the “swivel response time” is longer, the “swivel angular velocity” is slower, and the “swivel deviation value” is smaller for elder drivers.

In this embodiment, the ECU 20 is configured to adjust, on the basis of the “age” supplied as the driver information from the driver information input device 14, the swivel control angle SWC to be outputted to the actuators 11L, 11R which act to swivel the headlights 10L, 10R in accordance with the swivel control angle SWC.

More specifically, the swivel control angle SWC is adjusted such that the “swivel response time” (the time elapsed between a moment at which the steering wheel 17 is started to be turned and a moment at which the light axis adjustment of the headlights 10L, 10R actually starts) matches the “age”, the “the swivel angular velocity” (the rotational speed of the headlight 10L or 10R) matches the “age”, and the “swivel deviation value” (the fluctuation levels of the headlight 10L, 10R) is reduced by filtering to match the “age”. With this configuration, it becomes possible to perform the swivel control with excellent satisfactory performance quality for any age group.

As explained above, the apparatus for automatically adjusting a light axis of a headlight of a vehicle according to the embodiment of the invention has a structure including:
a steered angle sensor (18) detecting a steered angle (STA) of a steering wheel (17) of the vehicle;
a vehicle speed sensor (16L, 16R) detecting a speed of the vehicle;
a visual performance input device (14) for inputting driver information concerning a visual performance of a driver of the vehicle to the apparatus;
a control unit (20) calculating a light-axis control value (SWC) on the basis of the steered angle of the steering wheel detected by the steered angle sensor, the speed of the vehicle detected by the vehicle speed sensor, and at least one physical quantity related to the driver information; and
an actuator (11L, 11R) for swiveling the light axis of the headlight (10L, 10R) in accordance with the light-axis control value calculated by the control unit.

With this structure, it becomes possible to perform the swivel control while allowing for differences regarding visual performances among individuals.

As explained above, this embodiment uses the age of the driver for estimating the driver's visual performance based on the fact that the visual performance of human (such as the optical density, transmissivity, focus adjusting speed, and pupil diameter of a lens in an eyeball) varies with age. Accordingly, it becomes possible to perform the swivel control to every driver's satisfaction without difficulty. More specifically, this embodiment is configured to determine optimum “swivel response time”, “swivel angular velocity”, and “swivel deviation value” based on the age of the driver, and adjusts the swivel control angle SWC in accordance with the age of the driver. As a result, it becomes possible to adjust the light axes of the headlights 10L, 10R in a manner that satisfies the driver whatever visual performance the driver has.

Although the apparatus according to this embodiment of the invention has the driver information input device 14 that reads the driver information from an IC key, it may have a card reader instead if the driver information is prestored in an IC card. It is also possible to receive the driver information transmitted from the IC card by use of a radio receiver installed in the vehicle.

It is also possible for the driver directly input the age of the driver by use of the navigation system 15.

If the vehicle is provided with a device capable of measuring the visual performance (optical density, transmissivity, focus adjusting speed, or pupil diameter of a lens in an eyeball) of the driver, it becomes possible to adjust the swivel control angle SWC directly on the basis of the measured visual performance.

It is also possible to adjust the swivel control angle SWC on the basis of the level of unsteadiness of the steering operation of the driver or the level of wobbling of the vehicle. The level of unsteadiness of the steering operation can be measured from the output signal of the steered angle sensor 18. The level of wobbling of the vehicle can be measured from the difference between the output signals of the left and right wheel speed sensors 16L, 16R. The level of wobbling of the vehicle can be also measured from an output signal of a yaw rate sensor or a lateral acceleration sensor if they are mounted on the vehicle.

The above explained preferred embodiments are exemplary of the invention of the present application which is described solely by the claims appended below. It should be understood that modifications of the preferred embodiments may be made as would occur to one of skill in the art.

1. An apparatus for automatically adjusting a light axis of a headlight of a vehicle comprising:
a steered angle sensor detecting a steered angle of a steering wheel of said vehicle;
a vehicle speed sensor detecting a speed of said vehicle;
a visual performance input device for inputting driver information concerning a visual performance of a driver of said vehicle to said apparatus;
a control unit calculating a light-axis control value on the basis of said steered angle of said steering wheel detected by said steered angle sensor, said speed of said vehicle detected by said vehicle speed sensor, and at least one physical quantity related to said driver information; and
an actuator swiveling said light axis of said headlight in accordance with said light-axis control value calculated by said control unit.

2. An apparatus according to claim 1, wherein said visual performance is a value related to at least one of an optical density, a transmissivity, a focus adjusting speed, and a pupil diameter of a lens in an eyeball.

3. An apparatus according to claim 1, wherein said driver information is concerned with an age of said driver of said vehicle.

4. An apparatus according to claim 1, wherein said physical quantity is one of a swivel response time representing a time elapsed between a moment at which said steering wheel is started to be turned and a moment at which said actuator starts to swivel said light axis of said headlight, a swivel angular speed representing a rotational speed of said headlight being swiveled, and a swivel deviation value representing a fluctuation level in a lateral direction of said headlight being swiveled.
